(19) United States
(12) Patent Application Publication
(10) Pub. No.: US 2010/0065348 A1
(43) Pub. Date: Mar. 18, 2010

(54) APPARATUS FOR ASSISTING MOTION OF VEHICLES

(76) Inventor: Yadon Arad, Mountain View, CA (US)

Correspondence Address: PERKINS COIE LLP, P.O. BOX 1208, SEATTLE, WA, 98111-1208, US

(21) Appl. No.: 12/607,538

(22) Filed: Oct. 28, 2009

Related U.S. Application Data
(63) Continuation-in-part of application No. 12/208,291, filed on Sep. 10, 2008.
(60) Provisional application No. 61/246,935, filed on Sep. 29, 2009.

(51) Int. Cl. B62M 7/14; G06F 19/00

(52) U.S. Cl. 180/11; 701/22

(57) ABSTRACT

Apparatuses for assisting motion of vehicles are disclosed here. Embodiments of the present disclosure include an apparatus comprising, a charge-storage unit, an electromotor coupled to the charge-storage unit, wherein, at least a portion of the power supplied to the electromotor is supplied by the charge-storage unit. The apparatus may further include, a wheel powered by the electromotor to rotate in a plane about an axis, a housing, and a handle coupled to the housing, the handle being physically configured to, when, in operation, couple to an external entity to whom motion assistance is to be provided. The external entity may be a vehicle (e.g., a motor vehicle although other objects may be connected.

### CLAIM OF PRIORITY

This application claims priority to U.S. Provisional Patent Application Ser. No. 61/246,935 filed Sep. 29, 2009, entitled “A Power Module for Assisting Motion of Vehicles” by Yadon Arad, Attorney Docket No. 69158-8003.US00, which application is hereby incorporated by reference.

This application is a Continuation-In-Part of U.S. patent application Ser. No. 12/208,291 filed Sep. 10, 2008, entitled “A Power Module for Assisting Motion of Vehicles” by Yadon Arad, Attorney Docket No. 69158-8001.US01, which application is hereby incorporated by reference.

### FIELD OF TECHNOLOGY

The technology generally relates to decreasing the environmental impacts of vehicles. More specifically, it relates to an apparatus that can use electrical motors to assist the motion of vehicles to improve environmental friendliness.

### BACKGROUND

Vehicles based on internal-combustion-engines are ubiquitous in present day transportation. However, the same engines are culprits of a large percentage of the increased carbon-dioxide emissions and the increasing green-house effect. The limited supply of oil and natural gas, and world politics have resulted in increased price of oil and natural gas placing a severe financial burden on the average citizen of the planet.

The vehicle industry based on internal-combustion engines has been mature and is capable of manufacturing low cost vehicles, whereas vehicles based on electricity and other energy sources have not yet become conveniently available to the average person on the planet. Furthermore, there are millions of inefficient cars that are already in use and those cars will remain inefficient and will use oil for fuel until the owners manage to afford new fuel-efficient vehicles based on alternative energy sources.

### BRIEF DESCRIPTION OF THE DRAWINGS

FIG. 1 illustrates a diagrammatic view of a system of a composite vehicle having vehicle coupled to an apparatus that assists motion of the vehicle.

FIG. 2 depicts an example block diagram the apparatus for motion assistance.

FIG. 3 illustrates another diagrammatic view of a vehicle coupled to an apparatus that is equipped with a power cable.

FIG. 4 depicts a flow chart illustrating an example process for assisting the motion of vehicles.

FIG. 5A illustrates a top view of a wheel of the motion assistance apparatus.

FIG. 5B illustrates an example configuration of springs attached to the wheel 505 for reorientation.

FIG. 6 illustrates a vertical connector and a horizontal connector on the handle connecting the apparatus with the vehicle.

FIG. 7 illustrates an electromotor physically attached to the wheel in the motion assistance apparatus.

FIG. 8 illustrates a display unit and a lighting system of the motion assistance apparatus.

FIG. 9 depicts a flow chart illustrating another example process for assisting the motion of vehicles.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

As an alternative to oil and natural gas, electrical energy can be obtained from various renewable sources including but not limited to: wind, sun, geothermal sources. It can also be obtained from hydroelectric power plans which do not emit carbon-dioxide.

Embodiments of the present disclosure include a method and apparatus that uses electrical energy to move a vehicle (e.g., a motor vehicle) that otherwise uses an internal-combustion-engine. The electrical energy can be obtained from various sources including renewable sources to reduce fuel usage and to reduce carbon dioxide and/or other harmful emissions.

In one embodiment, an apparatus is coupled to a vehicle and provides at least a part of the force used to move the vehicle. The apparatus may be coupled to any part of the vehicle although generally to the rear.

In one embodiment, the apparatus includes, a wheel, an electromotor, an energy-storage device, and/or a handle operatively configured to couple the apparatus to the vehicle for motion assistance.

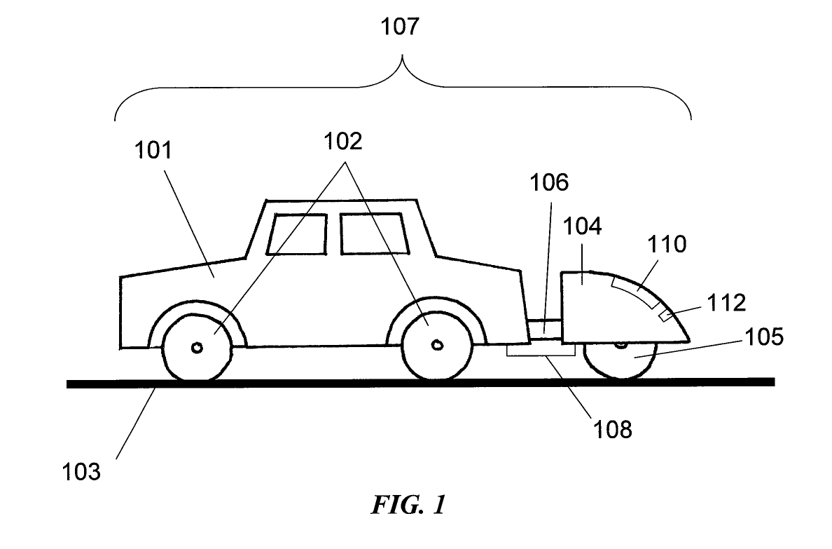

FIG. 1 illustrates a diagrammatic view of a system of a composite vehicle 107 having vehicle 101 coupled to an apparatus 104 (e.g., a motion assistance apparatus) that assists motion of the vehicle 101, according to one embodiment.

The vehicle 101 is typically powered by internal-combustion and/or any other means including but not limited to, solar, electrical, and any combination of the above. The vehicle 101 typically has a wheel 102 and is configured to move on a road 103.

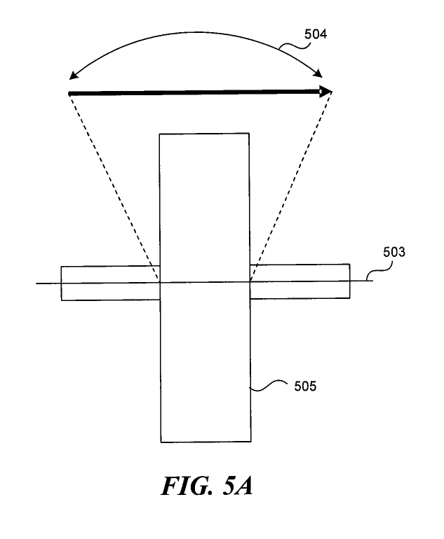

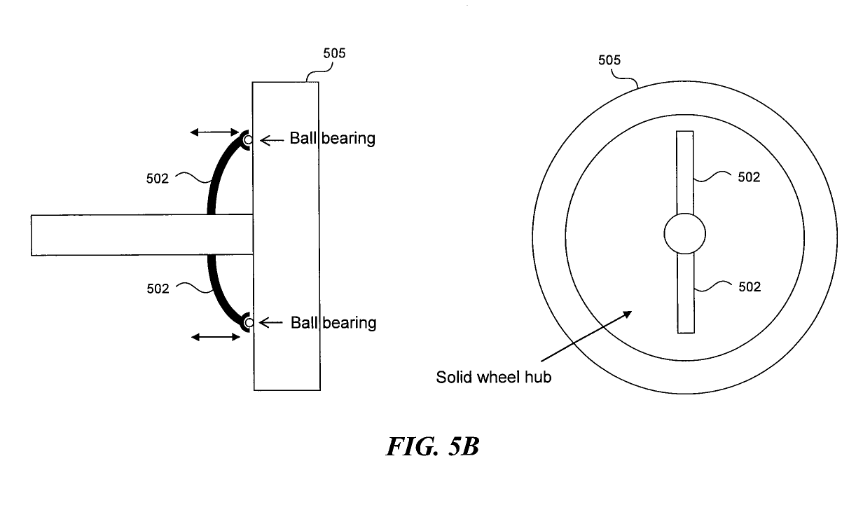

In some instances, the apparatus 104 is able to move relative to the vehicle 101 when attached (e.g., move towards and/or away from the vehicle), for example, using an interlocking gear system which can cause relative motion to be actuated manually (e.g., using a lever) or electrically (e.g., using an electrical engine). Although one wheel 105 is illustrated for the apparatus 104, additional wheels may be included as well. The wheel 105 of the apparatus 104 generally rotates about an axis in a plane. In some instances, the wheel 105 is able to rotate off the axis, as shown in the example of FIG. 5.

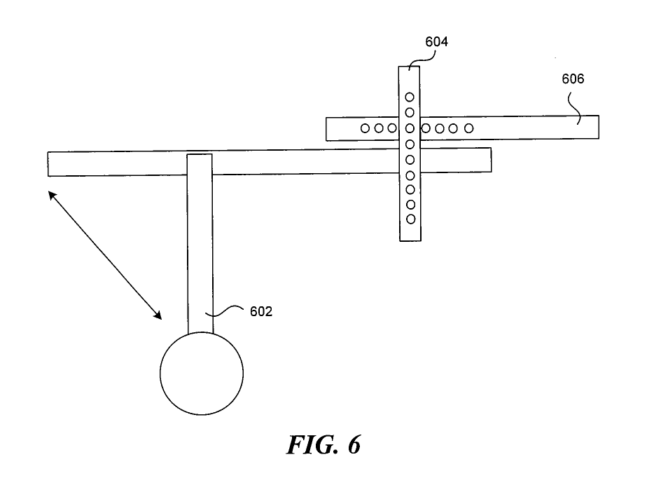

The apparatus 104 for assisting the motion of (e.g., assist acceleration or deceleration) the vehicle 101 can be coupled to the vehicle 101, for example, using a handle 106. The handle 106 may be implemented via any known or convenient manner, including but not limited to, a hook means, a magnetic means, a latch means, a lock means, etc. One embodiment of the handle 106 includes one or more connectors (e.g., a vertical connector and/or a horizontal connector), as shown in the example of FIG. 6. One embodiment of the apparatus 104 includes a wheel connected to the handle 106 which is foldable to facilitate easy maneuvering of the apparatus 104. The foldable wheel is illustrated with further reference to the example of FIG. 6.

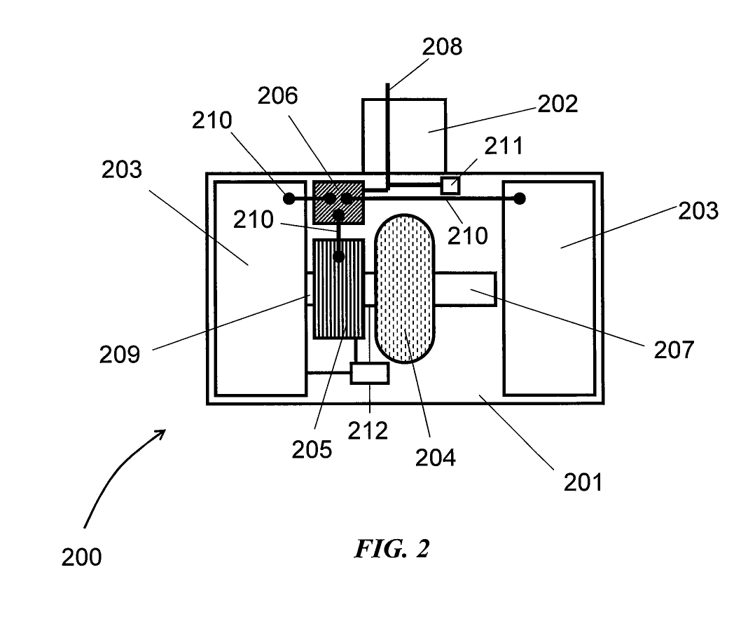

In one embodiment, the apparatus 104 comprises a wheel 105, an electromotor (illustrated with further reference in the example of FIG. 2), and/or an energy-storage unit (also illustrated with further reference to the example of FIG. 2). In some embodiments, the apparatus 104 may have two or more wheels as suitable for the vehicle 101 or for the particular conditions of the road 103.

The electromotor typically facilitates the movement of the vehicle 101 and the energy-storage unit can provide the energy/power required to do so. The energy-storage unit can also recharge based on internal energy generation means or via coupling to external sources. The energy storage unit may include a fuel cell comprised of H₂ and/or CH₄. For example, Instead of, or in addition to traditional energy storage systems, apparatus 104 may be powered by one or more fuel cells which derives the electrical energy from either H2 or CH4. H2 or CH4 in turn, are stored in storage tanks included in apparatus 104.

One embodiment includes a communication bus 108 though which the vehicle 101 and the apparatus 104 communicate.

In one embodiment, the apparatus 104 switches off when the car brakes are applied. For example, the electromotor in the apparatus 104 may be switched off The energy-storage unit can be charged by a regenerative braking system.

Furthermore, the apparatus 104 may include a display or screen 110 visible from external entities such as pedestrians or other cars driving on the road 103. The display or screen 110 may be used to display images and/or videos including but not limited to banners, advertisements or other promotional content, movies, pictures, and the like. The apparatus 104 may also include lighting 112 as brake lights and/or turning lights. As the vehicle 101 moves on the road 103 using fossil fuel, the apparatus 104 uses electrical energy. In one embodiment, the movement of the composite vehicle 107 is powered partially or wholly by the apparatus 104.

In some instances, the vehicle 101 includes peddles (e.g., peddles actuated by passenger's feet) which are coupled to a dynamo mechanism for recharging the battery of the apparatus 104. Any number of peddles may be used in the front or rear passenger seats.

FIG. 2 depicts an example block diagram the apparatus 200 for motion assistance, in accordance with embodiments of the present disclosure.

One embodiment of the apparatus 200 includes a wheel 204, an electromotor module 205, an energy storage unit 203, and/or a housing 201. Additional or less components may be included without deviating from the novel art of the disclosure. It is appreciated that some components may be partially or wholly integrated with one or more of the other components although the functions represented therein may be similar and are considered to be within the novel art of the disclosure.

One embodiment further includes a shaft apparatus 207, around which the wheel 204 can rotate. The wheel 204 is configured to rotate around the shaft apparatus 207 and relative to the housing 201. Additional wheels 204 and shaft apparatuses 207 may be included and is considered to be within the novel art of the disclosure.

In one embodiment, the electromotor 205 converts electrical power to mechanical power. In alternate embodiments, the electromotor 205 can be any device or module that is able to convert electrical power or any other type of power to mechanical power. Since the electromotor module 205 is coupled to the shaft apparatus 207, the wheel or set of wheels 204 can rotate (or be accelerated) when the electromotor module 205 is in operation. The electromotor module 205 and/or the shaft apparatus 207 may further be mechanically coupled to the housing 201.

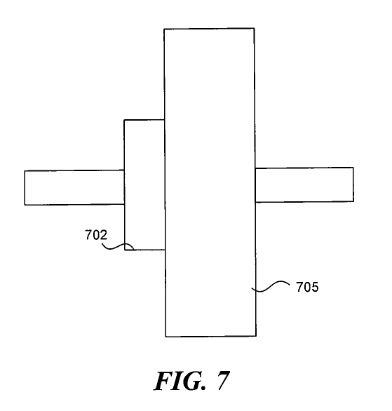

In one embodiment, the wheel 204 is physically attached to an electromotor (e.g., the electromotor 205 or another electromotor) which directly supplies rotational energy/power to the wheel 204, this example is illustrated with further reference to FIG. 7.

In one embodiment, the apparatus 200 includes a handle 202. The handle 202 can be configured to couple the housing 201 to a vehicle to which motion assistance is provided. The vehicle may be powered by internal combustion or other means, or a combination of means.

One embodiment includes optionally, a controller module 206 which can communicate with the vehicle via a communication bus 208. The controller module 206 can control the power flow between the energy-storage unit 203 and the electromotor module 205, for example, via power lines 210. The controller module 206 may be preprogrammed with a predetermine set of settings that determine the amount of energy to be stored in the energy-storage unit 203. In addition, the controller module 206 may be reconfigurable by a user (e.g., vehicle driver) or may be adaptable to usage conditions, environmental conditions in real-time or near real-time. In one embodiment, the energy-storage unit 203 includes fuel cells with H₂ and/or CH₄.

For example, Instead of, or in addition to traditional energy storage systems, apparatus 104 may be powered by one or more fuel cells which derives the electrical energy from either H2 or CH4. H2 or CH4 in turn, are stored in storage tanks included in apparatus 104.The electromotor module 205 may not be needed when the energy storage unit 203 uses fuel cell power sources.

One embodiment of the apparatus 200 includes a switch 209. The switch 209 can be coupled with the electromotor 205 and the energy-storage unit 203 to switch the power to the apparatus 200 on or off. For example, the switch 209 can switch off the electromotor 205 if the connected vehicle is detected to be in gear. In addition, the switch 209 can disconnect the power obtained from the energy-storage unit 203 if the connected vehicle is detected to be in motion.

In one embodiment, the apparatus 200 includes a detector 211 coupled to the bus 208. The detector 211 detects the gear in which the connected vehicle is operating. The switch 209 which may be coupled to the detector 211 can switch the electromotor 205 and/or the storage unit 203 based on the operating gear of the vehicle. For example, if the vehicle is in a moving gear or in breaking mode, the switch 209 can disconnect the electromotor 205 and/or the storage unit 203 to power off the apparatus 200. If the vehicle is in a non-moving gear (e.g., a neutral gear), the switch 209 can then connect the electro motor 205 and/or the storage unit 203 to power on the apparatus 200.

The communication bus 208 can be used to manage communications between the vehicle (e.g., the vehicle of the example in FIG. 1) and the apparatus 200. The information communicated between the vehicle and the apparatus 200 can include by way of example but not limitation, driving information, road conditions, gas mileage, gas level, rpm, wind strength, average speed, gear settings, gear shift, acceleration, deceleration, braking, cruising, etc. This information can be used by the apparatus 200 to determine the power and speed provided by the electromotor module 205 to assist the motion of the coupled vehicle. Although a wired bus is illustrated in FIGS. 1-2, in some embodiments, the vehicle and the apparatus 200 may communicate wirelessly.

One embodiment of the apparatus 200 includes a gear 212 coupled to the wheel 204. In one embodiment, the apparatus 200 is used to accelerate the vehicle by pushing the vehicle. This can occur when the electromotor module 205 is powered by electricity (e.g., the electricity stored in the energy-storage unit 203) or by electricity obtained elsewhere. In another embodiment, the apparatus 200 is used to slow down the vehicle and charge the energy-storage unit 203 during deceleration.

Note that although embodiments in the present example are described with specific reference to motion assistance in vehicles, it is appreciated the apparatus 200 can be used for motion assistance of other objects and entities, for similar or dissimilar purposes, without deviating from the scope of the disclosure.

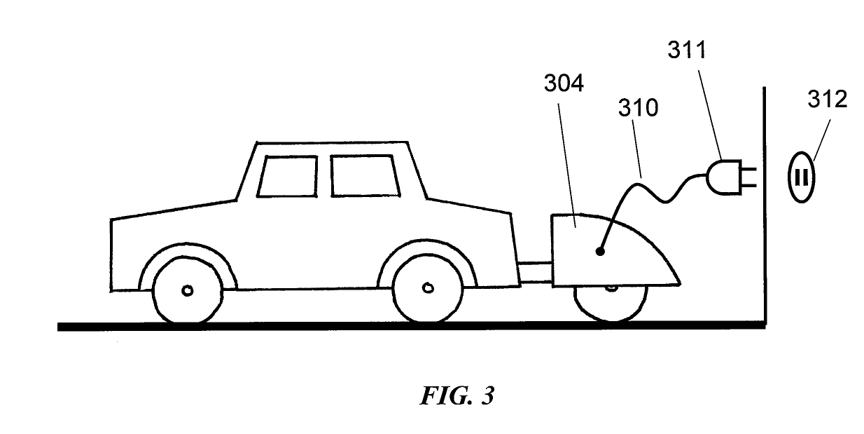

FIG. 3 illustrates another diagrammatic view of a vehicle coupled to an apparatus 304 that is equipped with a power cable 310, according to one embodiment.

In one embodiment, the apparatus 304 is further equipped with a power cable 310. The power cable can be used to replenish the charge or energy stored in the energy-storage unit (e.g., the energy storage unit 203 in the example of FIG. 2) in the apparatus 304 by plugging the power cable 310 into a power outlet 312.

The power plug 311 can be inserted into a power output such as a power outlet 312, common to many households and industry as a source of electrical power. It may also be plugged into a 220 Volt power outlet or to more sophisticate charging apparatuses which allows charging in as little as ten minutes. When the power plug 311 is inserted into the power outlet 312 (the receptacle 312) the energy-storage unit in the power module 304 is being charged.

In another embodiment, the apparatus 304 includes at least one solar cell. The solar cell can be used to obtain and energy from solar sources. In one embodiment, the solar cell is coupled to the energy-storage unit of the apparatus 304 to provide some or most of the energy to replenish the energy-storage unit.

In yet another embodiment, the vehicle coupled to the apparatus 304 includes at least one solar cell, the solar cell providing energy to replenish the energy-storage unit in the apparatus 304.

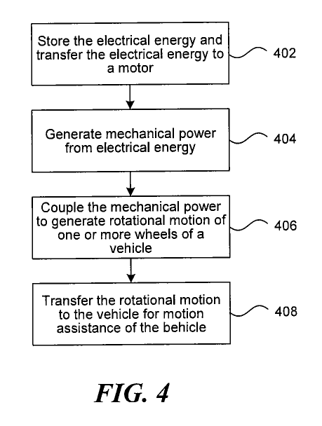

FIG. 4 depicts a flow chart illustrating an example process for assisting the motion of vehicles, according to one embodiment.

In process 402, the electrical energy is stored and transferred to a motor. In process 404, mechanical power is generated from electrical energy. In process 406, the mechanical power is coupled to generate rotational motion of the wheels of a vehicle. In process 408, the rotational motion is transferred to the vehicle for motion assistance of the vehicle.

FIG. 5A illustrates a top view of a wheel 505 of the motion assistance apparatus.

In some instances, the wheel 505 may be able to rotate off the axis 503 such that it rotates out of a vertical plane. Such rotational freedom allows the connected motion assistance apparatus to move about in conjunction with the motion assisted vehicle with more flexibility. In one embodiment, the wheel rotates out of the plane up to an angle 504 of approximately 30 degrees. The wheel 505 may be able to swing 15 degrees out of each side of the plane of rotation.

FIG. 5B illustrates an example configuration of springs 502 attached to the wheel 505 for reorientation.

One embodiment of the motion assistance apparatus includes a spring 502 coupled to the wheel 505. The spring 502 can pulls the wheel 505 back to rotate in the plane about the axis 503. One embodiment of the apparatus includes two springs 502. Any number of springs 502 may be connected to the wheel 505.

FIG. 6 illustrates a vertical connector 604 and/or a horizontal connector 606 on the handle connecting the apparatus with the vehicle.

Note that although both the vertical connector 604 and the horizontal connectors 606 are illustrated, either or both connectors are used optionally. The vertical connector 604, in one embodiment, includes multiple vertical connection locations. The different locations can be used to adjust how the vehicle connects to the motion assistance apparatus. Similarly, the horizontal connector 604 can include multiple horizontal connection locations. One embodiment further optionally includes a foldable wheel 602 which may be folded during installation of the apparatus to the vehicle. The wheel 602 may be in folded or unfolded position during operation (e.g., while assisting the motion of an attached vehicle).

FIG. 7 illustrates an electromotor 702 physically attached to the wheel 705 in the motion assistance apparatus e.g., “hub motor”). The electromotor 702 can directly power the wheel 705 for rotational motion, either in addition to or in lieu of the electromotor (e.g., the electromotor 204 shown in the example of FIG. 2).

For example, the electromotor 702 attached to the wheel 705 can be a tire-engine combo such that the tire is directly powered by the electromotor 702. Another electromotor may not be needed.

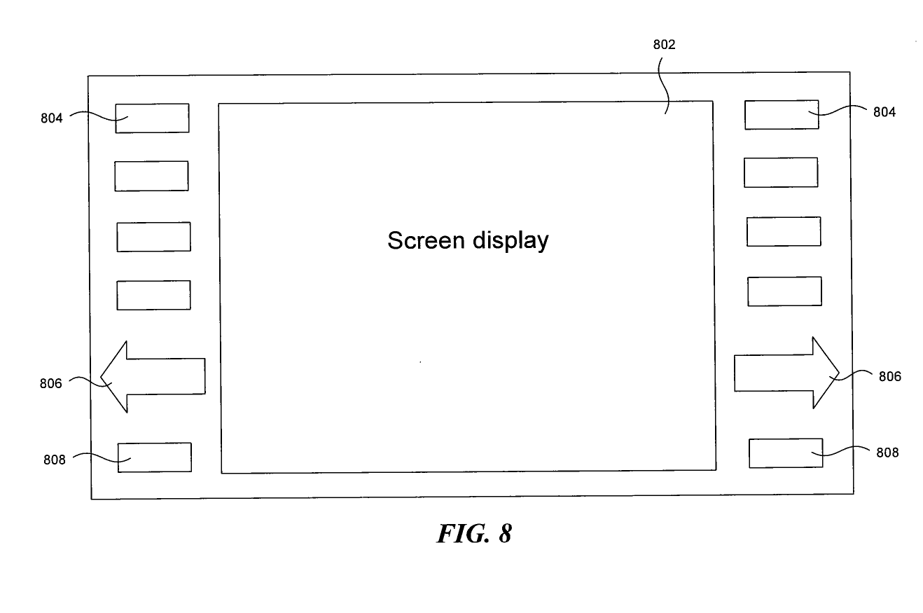

FIG. 8 illustrates a display unit 802 and a lighting system 804 and 806 of the motion assistance apparatus.

In general, the display unit 802 is positioned on the motion assistance apparatus to be visible from an opposite side of the motor vehicle coupled to the motion assistance apparatus. For example, the display unit 802 may be positioned on a rear end of the apparatus such that it is visible to a person driving a vehicle or pedestrian behind the attached vehicle.

The display unit 802 can depict lights such as brake lights and/or turn lights. The lighting system can also include brake lights 804 and/or turn lights 806. In addition, the display unit 802 can display alert and/or warning messages for other vehicles and/or pedestrians. In one embodiment, the display unit 802 also displays promotional content such as advertisements.

One embodiment of the motion assistance apparatus includes one or more cameras. For example, the cameras 808 can be mounted on the display unit 802. In one embodiment, the cameras are positioned on the motion assistance apparatus to capture a view from the opposite of the motor vehicle that is attached to the apparatus. The cameras can be used as a supplement to or in lieu of rear view mirrors and/or side mirrors. For example, the view can be continuously transmitted to the motor vehicle such that the driver can see the rear view of the vehicle.

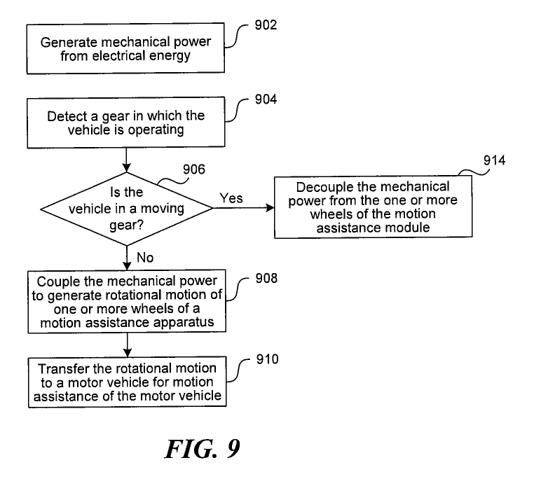

FIG. 9 depicts a flow chart illustrating another example process for assisting the motion of vehicles.

In process 902, mechanical power is generated from electrical energy. The mechanical power can be generated from an electromotor. The electromotor can obtain electrical energy from various sources including but not limited to an attached energy storage unit (e.g., a battery), solar power, wind power, an electrical plug, etc.

In process 904, the gear in which the vehicle is operating is detected. By detecting the gear, it can be determined whether the vehicle is in motion (e.g., whether the vehicle is being powered by internal transmission and engine). In process 906, it is determined whether the vehicle is in a moving gear. If not, the mechanical power is coupled to generate rotational motion of the wheels of the motion assistance apparatus in process 908. In process 910, the rotational motion is transferred to the motor vehicle for motion assistance of the motor vehicle.

If the vehicle is in a moving gear or in breaking mode then the mechanical power can be decoupled from the wheels in process 914. To decouple the mechanical power, the electromotor may be switched off by disconnecting or switching off the source of electrical power (e.g., battery, solar, electrical plug, etc.).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. An apparatus, comprising:
a charge-storage unit;
an electromotor coupled to the charge-storage unit;
wherein, at least a portion of the power supplied to the electromotor is supplied by the charge-storage unit;
a wheel powered by the electromotor to rotate in a plane about an axis;
a housing; and
a handle coupled to the housing;
wherein, the handle is configured to, couple to an external entity to which motion assistance is to be provided.

2. The apparatus of claim 1, wherein, the wheel is able to rotate off the axis.

3. The apparatus of claim 2, wherein, the wheel rotates off the axis such that it is rotating out of the plane up to approximately 15 degrees to each side of the plane.

4. The apparatus of claim 2,
further comprising, a spring coupled to the wheel;
wherein, the spring pulls the wheel back to rotate in the plane about the axis.

5. The apparatus of claim 1, wherein, the handle further comprises:
a vertical connector having multiple vertical connection locations for connection to the external entity;
a horizontal connector having multiple horizontal connection locations for connection to the external entity.

6. The apparatus of claim 1,
further comprising, another wheel attached to the handlebar;
wherein, the another wheel is foldable.

7. The apparatus of claim 1, wherein, the external entity is a vehicle employing an internal combustion engine.

8. The apparatus of claim 7, further comprising:
a detector to detect whether a gear in which vehicle is operating and when breaks of the vehicle are applied;
a switch connected to the detector;
wherein, when the vehicle is in moving gear or in a breaking mode, the switch disconnects the electromotor and when the vehicle is in neutral gear, the switch connects the electromotor.

9. The apparatus of claim 1, further comprising, a controller module, coupled to the electromotor and the charge-storage unit to control energy and power flow; wherein the controller module is one or more of, preprogrammed, configurable, and re-configurable.

10. The apparatus of claim 1, wherein, the electromotor is coupled to the movable portion via a shaft to which the wheel is coupled.

11. The apparatus of claim 1, wherein, the wheel is physically attached to the electromotor which directly supplies power to the wheel.

12. The apparatus of claim 1, further comprising,
a communication bus;
a lighting system connected to electrical system of the vehicle through the communication bus;
wherein, the lighting system includes a brake light and a turning light.

13. The apparatus of claim 1,
further comprising a power cable suitable for being plugged into a power outlet;
wherein energy obtained from the power cable is stored in the charge-storage unit.

14. A system of a motion-assisted vehicle, comprising:
a motion assistance apparatus having:
a charge-storage unit;
an electromotor coupled to the charge-storage unit;
wherein, at least a portion of the power supplied to the electromotor is supplied by the charge-storage unit;
two wheels powered by the electromotor
a housing coupled to the electromotor;
a handle coupled to the housing;
a foldable wheel connected to the handle;
a motor vehicle coupled to the motion assistance apparatus at the handle;
wherein, the motion assistance apparatus is able to move relative to the vehicle when in motion.

15. The system of claim 14,
further comprising, a display unit coupled to the motion assistance apparatus;
wherein, the display unit is positioned on the motion assistance apparatus to be visible from an opposite side of the motor vehicle coupled to the motion assistance apparatus.

16. The system of claim 15,
further comprising, a camera positioned on the motion assistance apparatus to capture a view from the opposite of the motor vehicle;
wherein, the view is continuously transmitted to the motor vehicle.

17. The system of claim 15, wherein, the camera is mounted on the display unit.

18. The system of claim 15, wherein, the display unit depicts a brake light and/or a turn light.

19. The system of claim 15, wherein, the display unit displays alert or warning messages for other vehicles or pedestrians.

20. The system of claim 15, wherein, the display unit displays advertisements.

21. The system of claim 13, wherein, the motion assistance apparatus is able to move towards and/or away from the vehicle.

22. A method for providing environmentally friendly transportation, the method, comprising:
generating mechanical power from electrical energy;
detecting a gear in which the vehicle is operating or when breaking;
in response to detecting that the vehicle is not in a moving gear or in breaking mode, coupling the mechanical power to generate rotational motion of one or more wheels of a motion assistance module;
transferring the rotational motion to a motor vehicle for motion assistance of the motor vehicle;
wherein, the motion assistance comprise assistance in acceleration or deceleration of the vehicle;
in response to detecting that the vehicle is in a moving gear, decoupling the mechanical power from the one or more wheels of the motion assistance module;
wherein, the motion assistance comprise assistance in acceleration or deceleration of the vehicle.
